(19) United States
(12) Patent Application Publication
(10) Pub. No.: US 2015/0218034 A1
(43) Pub. Date: Aug. 6, 2015

(54) EDGE TRIM MANAGEMENT FOR FLEXIBLE GLASS RIBBON

(71) Applicants: Donald Orrin BIGELOW, (US); Robertson Dewhurst BOOTH, (US); Richard Jonathan KOHLER, (US); CORNING INCORPORATED, Corning, NY (US)

(72) Inventors: Donald Orrin Bigelow, Honeoye Falls, NY (US); Robertson Dewhurst Booth, Elmira, NY (US); Richard Jonathan Kohler, Hilton, NY (US)

(21) Appl. No.: 14/429,969

(22) PCT Filed: Sep. 26, 2013
(86) PCT No.: PCT/US2013/061855

§ 371 Date: Mar. 20, 2015

Related U.S. Application Data
(60) Provisional application No. 61/705,781, filed on Sep. 26, 2012.

(51) Int. Cl. C03B 33/023; B26D 7/18

(52) U.S. Cl. CPC C03B 33/0235; B26D 7/18

(57) ABSTRACT

A method of managing edge trim of a flexible glass ribbon includes directing the flexible glass ribbon to an edge trimming apparatus including a cutting device. The flexible glass ribbon includes a first broad surface and a second broad surface that extend laterally between a first edge and a second edge. The first edge of the flexible glass ribbon is separated as the flexible glass ribbon moves by the cutting device forming a continuous strip of edge trim connected to a central portion of the flexible glass ribbon. The continuous strip of edge trim is collected separate from the central portion while the continuous strip of edge trim remains connected to the central portion of the flexible glass ribbon.

This application claims the benefit of priority under 35 U.S.C. §119 of U.S. Provisional Application Ser. No. 61/705781, filed on Sep. 26, 2012, the content of which is relied upon and incorporated herein by reference in its entirety.

### TECHNICAL FIELD

The present invention relates to apparatuses and methods for managing edge trim from flexible glass ribbon.

### BACKGROUND

Glass manufacturing apparatus are commonly used to form various glass products such as LCD sheet glass. Glass substrates in flexible electronic applications are becoming thinner and lighter. Glass substrates having thicknesses lower than 0.5 mm, such as less than 0.3 mm, such as 0 1 mm or even thinner can be desirable for certain display applications, especially portable electronic devices such as laptop computers, handheld devices and the like. It is known to manufacture glass ribbon by downwardly flowing molten glass over a forming wedge and using edge rollers to engage beads formed at opposite edge portions of a glass ribbon.

### SUMMARY

The present concept involves managing edge trim of a flexible glass ribbon. The edge trim may be removed from a central portion of the flexible glass ribbon in a continuous fashion by an edge trimming apparatus. The continuous strip of edge trim is then collected while the continuous strip of edge trim remains connected to the central portion of the flexible glass ribbon and can eliminate any need for handling relatively small pieces of thin flexible glass edge trim. As used herein the term “edge trim” means the un-usable (or non-quality) portions of the glass ribbon that are to be discarded, for example, portions of the glass ribbon including beads or thickened portions at the edges, or portions of the glass ribbon including edge tape or other protective material on the edge of the glass ribbon meant to protect the edges of the glass ribbon.

One commercial advantage to the present approach is that manufacturers can collect and remove the edge trim without any need for chopping or crushing the edge trim once it is removed. This can provide a cleaner environment in which the flexible glass ribbon can be processed. Manufactures can also collect and remove edge trim that includes the flexible glass along with any coating materials or adhesive tape applied thereto.

According to a first aspect, a method of managing edge trim of a flexible glass ribbon comprises:
directing the flexible glass ribbon to an edge trimming apparatus including a cutting device, the flexible glass ribbon including a first broad surface and a second broad surface that extend laterally between a first edge and a second edge;
separating the first edge of the flexible glass ribbon as the flexible glass ribbon moves by the cutting device forming a continuous strip of edge trim connected to a central portion of the flexible glass ribbon; and
collecting the continuous strip of edge trim separate from the central portion while the continuous strip of edge trim remains connected to the central portion of the flexible glass ribbon.

According to a second aspect, there is provided the method of aspect 1, further comprising applying an adhesive tape to the first edge of the flexible glass ribbon prior to removing the first edge of the flexible glass ribbon.

According to a third aspect, there is provided the method of aspect 1 or aspect 2, wherein the continuous strip of edge trim includes the adhesive tape.

According to a fourth aspect, there is provided the method of anyone of aspects 1-3, wherein the cutting device comprises a laser directing a laser beam onto at least one of the first broad surface and the second broad surface.

According to a fifth aspect, there is provided the method of aspect 4, further comprising directing a cooling jet onto the at least one of the first broad surface and the second broad surface thereby cooling the flexible glass ribbon at a location proximate the laser beam.

According to a sixth aspect, there is provided the method of any one of aspects 1-5, wherein the step of collecting the continuous strip of edge trim includes winding the continuous strip of edge trim on a roll assembly.

According to a seventh aspect, there is provided the method of aspect 6, wherein the roll assembly includes a drive shaft and a winding roll disposed about the drive shaft.

According to an eighth aspect, there is provided the method of aspect 7, comprising winding the continuous strip of edge trim on the winding roll.

According to a ninth aspect, there is provided the method of aspect 7 or aspect 8, further comprising removing the winding roll from the drive shaft, the continuous strip of edge trim being disposed about the winding roll.

According to a tenth aspect, a method of managing edge trim of a flexible glass ribbon comprises:

separating a first edge of the flexible glass ribbon using an edge trimming apparatus thereby forming a continuous strip of edge trim connected to a central portion of the flexible glass ribbon; and
winding the continuous strip of edge trim about a roll of a roll assembly while the continuous strip of edge trim remains connected to the central portion of the flexible glass ribbon.

According to an eleventh aspect, there is provided the method of aspect 10, comprising rotating the roll using a motor.

According to a twelfth aspect, there is provided the method of any one of aspect 10 or aspect 11, wherein the roll is removable from a drive shaft.

According to a thirteenth aspect, there is provided the method of aspect 12, further comprising removing the roll from the drive shaft, the continuous strip of edge trim being disposed about the roll.

According to a fourteenth aspect, there is provided the method of any one of aspects 10-13, further comprising applying an adhesive tape to the first edge of the flexible glass ribbon prior to separating the first edge of the flexible glass ribbon.

According to a fifteenth aspect, there is provided the method of aspect 14, wherein the continuous strip of edge trim includes the adhesive tape.

According to a sixteenth aspect, there is provided the method of any one of aspects 10-15, wherein the edge trimming apparatus comprises a laser directing a laser beam onto at least one of a first broad surface and a second broad surface of the flexible glass ribbon.

According to a seventeenth aspect, there is provided the method of aspect 16, further comprising directing a cooling jet onto the at least one of the first broad surface and the second broad surface thereby cooling the flexible glass ribbon at a location proximate the laser beam.

According to an eighteenth aspect, an apparatus that manages edge trim of a flexible glass ribbon comprises:
a conveying assembly that directs the flexible glass ribbon in a conveying direction;
an edge trimming apparatus including a cutting device, the cutting device receives the flexible glass ribbon as the flexible glass ribbon moves in the conveying direction and separates a first edge of the flexible glass ribbon as the flexible glass ribbon moves by the cutting device forming a continuous strip of edge trim connected to a central portion of the flexible glass ribbon; and
a roll assembly that collects the continuous strip of edge trim separate from the central portion while the continuous strip of edge trim remains connected to the central portion of the flexible glass ribbon.

According to a nineteenth aspect, there is provided the apparatus of aspect 18, wherein the roll assembly comprises a drive shaft that is driven by a motor and a roll received by the drive shaft, the continuous strip of edge trim winding about the roll.

According to a twentieth aspect, there is provided the apparatus of aspect 19, wherein the drive shaft is expandable.

According to a twenty-first aspect, there is provided the apparatus of aspect 18 or aspect 19, wherein the drive shaft comprises a differential drive shaft assembly.

Additional features and advantages will be set forth in the detailed description which follows, and in part will be readily apparent to those skilled in the art from the description or recognized by practicing the invention as exemplified in the written description and the appended drawings and as defined in the appended claims. It is to be understood that both the foregoing general description and the following detailed description are merely exemplary of the invention, and are intended to provide an overview or framework to understanding the nature and character of the invention as it is claimed.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features of the invention disclosed in this specification and in the drawings can be used in any and all combinations.

### BRIEF DESCRIPTION OF THE DRAWINGS

FIG. 1 is a partial view of an embodiment of an apparatus for processing a flexible glass ribbon;

FIG. 2 is a section view along line 2-2 of FIG. 1 illustrating an embodiment of a cutting support member with an upwardly extending convex support surface;

FIG. 3 illustrates another embodiment of a cutting support member with an upwardly facing concave support surface;

FIG. 4 illustrates a schematic view of an embodiment of an apparatus for processing a flexible glass ribbon;

FIG. 5 illustrates an embodiment of a roll assembly for collecting a continuous strip of edge trim from the flexible glass ribbon;

FIG. 6 illustrates another embodiment of a roll assembly for collecting a continuous strip of edge trim from the flexible glass ribbon;

FIG. 7 illustrates another embodiment of a roll assembly for collecting a continuous strip of edge trim from the flexible glass ribbon;

FIG. 8 illustrates another embodiment of a roll assembly for collecting a continuous strip of edge trim from the flexible glass ribbon; and

FIG. 9 illustrates a system and method for controlling tension in a continuous strip of edge trim from the flexible glass ribbon.

### DETAILED DESCRIPTION

Embodiments described herein generally relate to processing of flexible glass ribbon and, more particularly, to management of strips of flexible glass removed from the flexible glass ribbon in a continuous fashion without chopping, breaking or crushing the strips of flexible glass into smaller pieces. The continuous strips of flexible glass may be separated from a central portion of the flexible glass ribbon and then collected (e.g., about a roll), while remaining connected to the central portion of the flexible glass ribbon.

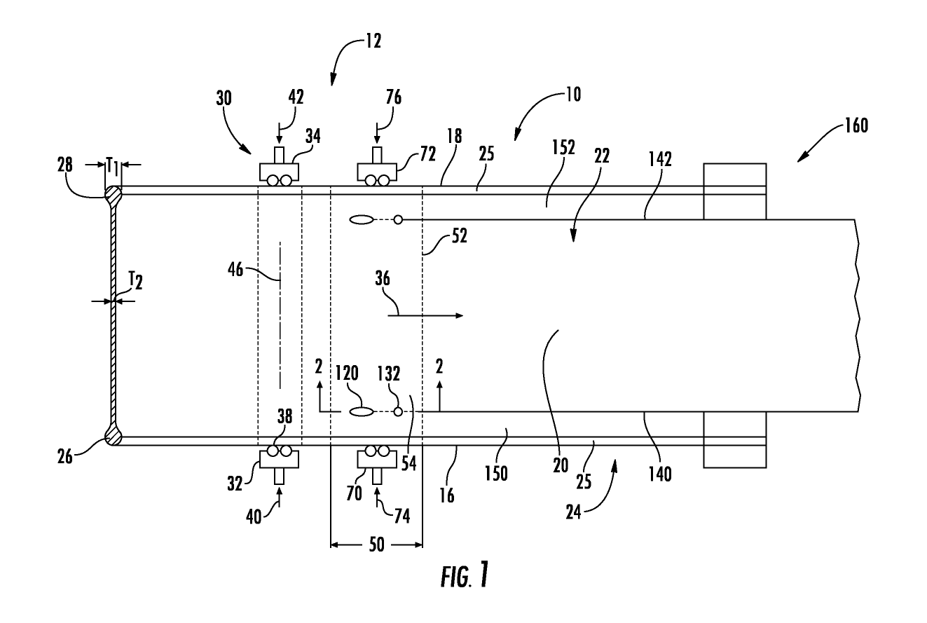

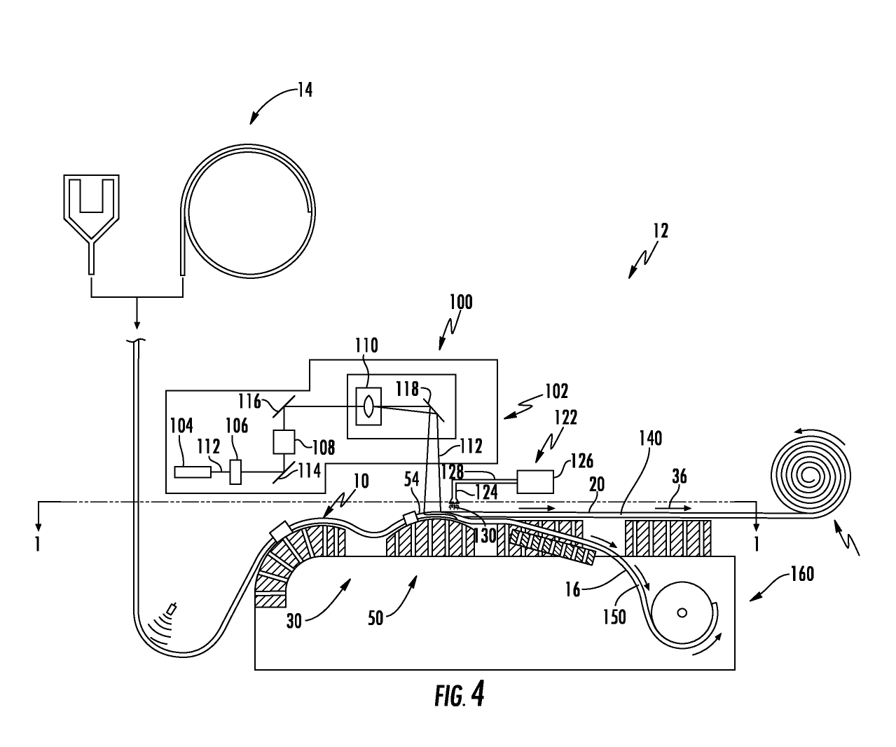

Referring to FIG. 1, a flexible glass ribbon 10 is illustrated being conveyed through a glass processing apparatus 12, only a portion of which is illustrated by FIG. 1. The flexible glass ribbon 10 may be conveyed in a continuous fashion from a glass ribbon source 14 (FIG. 4) through the glass processing apparatus 12. The flexible glass ribbon 10 includes a pair of opposed first and second edges 16 and 18 that extend along a length of the flexible glass ribbon 10 and a central portion 20 that spans between the first and second edges 16 and 18. In some embodiments, the first and second edges 16 and 18 may be covered in an adhesive tape 25 that is used to protect and shield the first and second edges 16 and 18 from contact. The tape 25 may be applied to one or both of the first and second edges 16 and 18 as the flexible glass ribbon 10 moves through the apparatus 12. A first broad surface 22 and an opposite, second broad surface 24 also spans between the first and second edges 16 and 18, forming part of the central portion 20.

In embodiments where the flexible glass ribbon 10 is formed using a down draw fusion process, which is shown in part in FIG. 4, the first and second edges 16 and 18 may include beads 26 and 28 with a thickness T₁ that is greater than a thickness T₂ within the central portion 20. The central portion 20 may be “ultra-thin” having a thickness T₂ of about 0.3 mm or less including but not limited to thicknesses of, for example, about 0.01-0.05 mm, about 0.05-0.1 mm, about 0.1-0.15 mm and about 0.15-0.3 mm, although flexible glass ribbons 10 with other thicknesses (for example 0.01, 0.02. 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, or 0.3 mm) may be formed in other examples.

The flexible glass ribbon 10 is conveyed through the apparatus 12 using a conveyor system 30 (FIG. 4). Lateral guides 32 and 34 may be provided to orient the flexible glass ribbon 10 in the correct lateral position relative to the machine or travel direction 36 of the flexible glass ribbon 10. For example, as schematically shown, the lateral guides 32 and 34 may include rollers 38 that engage the first and second edges 16 and 18. Opposed forces 40 and 42 may be applied to the first and second edges 16 and 18 using the later guides 32 and 34 that help to shift and align the flexible glass ribbon 10 in the desired lateral orientation in the travel direction 36.

As further illustrated, the lateral guides 32 and 34 can engage the first and second edges 16 and 18 on the tape 25 without engaging the central portion 20 of the flexible glass ribbon 10. As such, the pristine or quality surfaces of the opposed first and second broad surfaces 22 and 24 of the central portion 20 of the flexible glass ribbon 10 can be maintained while avoiding undesired scratching or other surface contamination that might otherwise occur if the lateral guides 32 and 34 were to engage either of the first and second broad surfaces 22 and 24 of the central portion 20. Moreover, the lateral guides 32 and 34 may engage the flexible glass ribbon 10 as it is being bent about an axis 46 transverse to the travel direction 36 of the flexible glass ribbon 10. Bending the flexible glass ribbon 10, as will be described in greater detail below, can increase the rigidity of the glass ribbon 10 throughout the bend. As such, the lateral guides 32 and 34 can engage the glass ribbon 10 in a bent condition. The forces 40 and 42 applied by the lateral guides 32 and 34 are therefore less likely to buckle or otherwise disturb the stability of the glass ribbon profile when laterally aligning as the flexible glass ribbon 10.

The apparatus 12 can further include a cutting zone 50 downstream from the axis 46. In one example, the apparatus 12 may include a cutting support member 52 configured to bend the flexible glass ribbon 10 in the cutting zone 50 to provide a bent target segment 54 with a bent orientation. Bending the target segment 54 within the cutting zone 50 can help stabilize the flexible glass ribbon 10 during the cutting procedure. Such stabilization can help prevent buckling or disturbing the flexible glass ribbon profile during the procedure of separating at least one of the first and second edges 16 and 18 from the central portion 20 of the flexible glass ribbon 10.

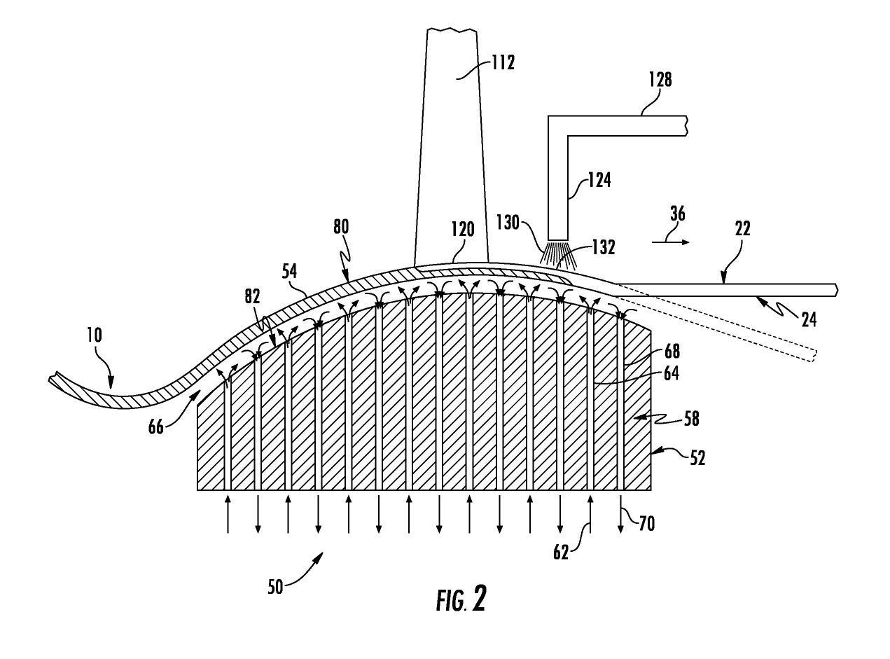

The cutting support member 52 can comprise a non-contact cutting support member 52 designed to support the glass ribbon 10 without touching the first and second broad surfaces 22 and 24 of the flexible glass ribbon 10. For example, referring to FIG. 2, the non-contact cutting support member 56 can comprise one or more curved air bars configured to provide a cushion of air to space between the flexible glass ribbon 10 and the cutting support member 52 to prevent the central portion 20 of the flexible glass ribbon 10 from contacting the cutting support member 52.

Referring to FIG. 2, the cutting support member 52 can be provided with a plurality of passages 58 configured to provide positive pressure ports 60 such that an air stream 62 can be forced through the positive pressure ports 64 toward the bent target segment 54 to create an air cushion 66 for non-contact support of the bent target segment 54. Optionally, the plurality of passages 58 can include negative pressure ports 68 such that an air stream 70 can be drawn away from the bent target segment 54 to create a suction to partially counteract the force from the air cushion 66 created by the positive pressure ports 64. A combination of positive and negative pressure ports can help stabilize the bent target segment 54 throughout the cutting procedure. Indeed, the positive pressure ports 64 can help maintain a desired air cushion 66 height between the central portion 20 of the flexible glass ribbon 10 and the cutting support member 52. At the same time, the negative pressure ports 68 can help pull the flexible glass ribbon 10 toward the cutting support member 52 to prevent the flexible glass ribbon 10 from undulating or having portions of the bent target segment 54 from floating away from other portions of the target segment 54 when traversing over the cutting support member 52 in the travel direction 36.

Providing the bent target segment 54 in the cutting zone 50 can also increase the rigidity of the flexible glass ribbon 10 throughout the cutting zone 50. As such, as shown in FIG. 1, optional lateral guides 70, 72 can engage the flexible glass ribbon 10 in a bent condition as the flexible glass ribbon 10 passes over the cutting support member 52 within the cutting zone 50. Forces 74 and 76 applied by the lateral guides 70 and 72 are therefore less likely to buckle or otherwise disturb the stability of the glass ribbon profile when laterally aligning as the flexible glass ribbon 10 passes over the cutting support member 52. The optional lateral guides 70 and 72 can therefore be provided to fine tune the bent target segment 54 at the proper lateral orientation along a direction of the axis 46 transverse to the travel direction 36 of the flexible glass ribbon 10.

As set forth above, providing the bent target segment 54 in a bent orientation within the cutting zone 50 can help stabilize the flexible glass ribbon 10 during the cutting procedure. Such stabilization can help prevent buckling or disturbing the glass ribbon profile during the procedure of separating at least one of the first and second edges 16 and 18. Moreover, the bent orientation of the bent target segment 54 can increase the rigidity of the bent target segment 54 to allow optional fine tune adjustment of the lateral orientation of the bent target segment 54. As such, the flexible glass ribbon 10 can be effectively stabilized and properly laterally oriented without contacting the first and second broad surfaces 22 and 24 of the central portion 20 during the procedure of separating at least one of the first and second edges 16 and 18.

Increased stabilization and rigidity of the bent target segment 54 of the flexible glass ribbon 10 can be achieved by bending the target segment 54 to include an upwardly convex surface and/or an upwardly concave surface along a direction of the axis 46. For example, as shown in FIG. 2, the bent target segment 54 includes a bent orientation with an upwardly facing convex surface 80. Examples of the disclosure can involve supporting the bent target segment 54 with an upwardly facing convex support surface 82 of the cutting support member 52, such as the illustrated air bar. Providing the cutting support member 52 with an upwardly facing convex support surface 82 can likewise bend the flexible glass ribbon 10 in the cutting zone 50 to achieve the illustrated bent orientation.

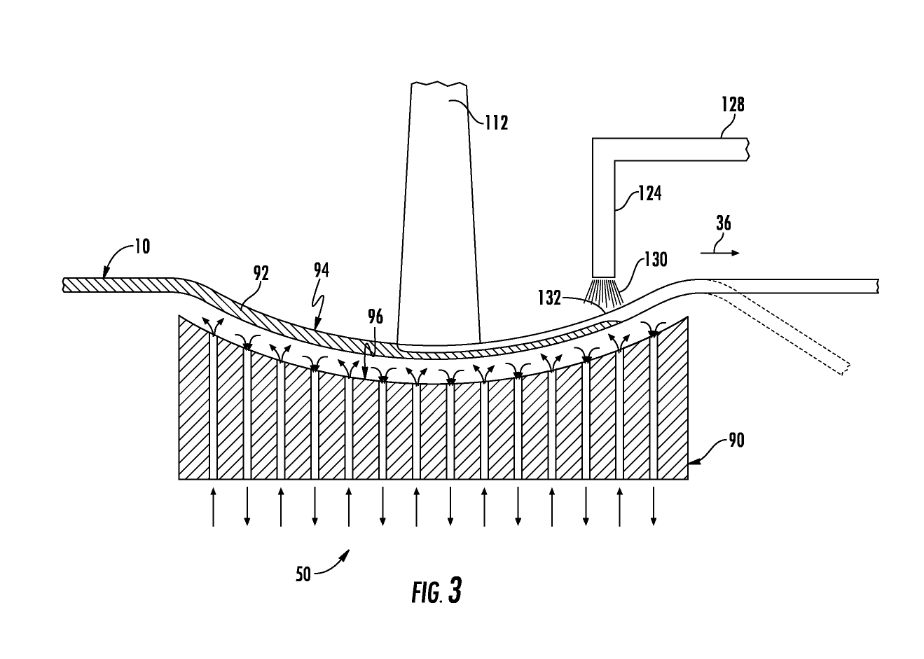

In another example, as shown in FIG. 3, another cutting support member 90 can be provided that is similar to the cutting support member 52 illustrated in FIG. 2. However, as shown in FIG. 3, the cutting support member 90 can be provided to support a bent target segment 92 in a bent orientation with an upwardly facing concave surface 94. Therefore, further examples of the disclosure can involve supporting the bent target segment 92 with an upwardly facing concave support 96 of the cutting support member 90 such as the illustrated air bar. As shown in FIG. 3, providing the cutting support member 90 with an upwardly facing concave support surface 96 can likewise bend the flexible glass ribbon 10 in the cutting zone 50 to achieve the illustrated bent orientation with the upwardly facing concave surface 94.

The apparatus 12 can further include a wide range of edge trimming apparatus configured to separate the first and second edges 16 and 18 from the central portion 20 of the glass ribbon 10. In one example, as shown in FIG. 4, one example edge trimming apparatus 100 can include an optical delivery apparatus 102 for irradiating and therefore heating a portion of the upwardly facing surface of the bent target segment 54. In one example, optical delivery apparatus 102 can comprise a cutting device such as the illustrated laser 104 although other radiation sources may be provided in further examples. The optical delivery apparatus 102 can further include a circular polarizer 106, a beam expander 108, and a beam shaping apparatus 110.

The optical delivery apparatus 102 may further comprise optical elements for redirecting a beam of radiation (e.g., laser beam 112) from the radiation source (e.g., laser 104), such as mirrors 114, 116 and 118. The radiation source can comprise the illustrated laser 104 configured to emit a laser beam having a wavelength and a power suitable for heating the flexible glass ribbon 10 at a location where the beam is incident on the flexible glass ribbon 10. In one embodiment, laser 104 can comprise a CO₂ laser although other laser types may be used in further examples.

The laser 104 may be configured to initially emit the laser beam 112 with a substantially circular cross section (i.e. the cross section of the laser beam at right angles to the longitudinal axis of the laser beam). The optical delivery apparatus 102 is operable to transform laser beam 112 such that the beam 112 has a significantly elongated shape when incident on glass ribbon 10. As shown in FIG. 1, the elongated shape can produce an elongated radiation zone 120 that may include the illustrated elliptical footprint although other configurations may be provided in further examples. The elliptical foot print can be positioned on the upwardly facing convex or concave surface of the bent target segment.

The boundary of the elliptical footprint can be determined as the point at which the beam intensity has been reduced to 1/e² of its peak value. The laser beam 112 passes through circular polarizer 106 and is then expanded by passing through beam expander 108. The expanded laser beam 112 then passes through beam shaping apparatus 110 to form a beam producing the elliptical footprint on a surface of the bent target segment 54. The beam shaping apparatus 110 may, for example, comprise one or more cylindrical lenses. However, it should be understood that any optical elements capable of shaping the beam emitted by laser 104 to produce an elliptical footprint on the bent target segment 54 may be used.

The elliptical footprint can include a major axis that is substantially longer than a minor axis. In some embodiments, for example, major axis is at least about ten times longer than minor axis. However, the length and width of the elongated radiation zone are dependent upon the desired separating speed, desired initial crack size, thickness of the glass ribbon, laser power, etc., and the length and width of the radiation zone may be varied as needed.

As further shown in FIG. 4, the example glass cutting device 100 can also include a coolant fluid delivery apparatus 122 configured to cool the heated portion of the upwardly facing surface of the bent target segment 54. The coolant fluid delivery apparatus 122 can comprise a coolant nozzle 124, a coolant source 126 and an associated conduit 128 that may convey coolant to the coolant nozzle 124.

With reference to FIG. 1, the coolant nozzle 124 can be configured to deliver a coolant jet 130 of coolant fluid to the upwardly facing surface of the bent target segment 54. The coolant nozzle 124 can have various internal diameters to form a cooling zone 132 of a desired size. As with elongated radiation zone 120, the diameter of coolant nozzle 124, and the subsequent diameter of coolant jet 130, may be varied as needed for the particular process conditions. In some embodiments, the area of the glass ribbon immediately impinged upon by the coolant (cooling zone 132) can have a diameter shorter than the minor axis of the radiation zone 120. However, in certain other embodiments, the diameter of the cooling zone 132 may be larger than the minor axis of elongated radiation zone 120 based on process conditions such as speed, glass thickness, laser power, etc. Indeed, the (cross sectional) shape of the coolant jet may be other than circular, and may, for example, have a fan shape such that the cooling zone forms a line rather than a circular spot on the surface of the glass ribbon. A line-shaped cooling zone may be oriented, for example, perpendicular to the major axis of elongated radiation zone 120. Other shapes may be beneficial.

In one example, the coolant jet 130 comprises water, but may be any suitable cooling fluid (e.g., liquid jet, gas jet or a combination thereof) that does not stain or damage the upwardly facing surface of the bent target segment 54 of the flexible glass ribbon 10. The coolant jet 130 can be delivered to a surface of the flexible glass ribbon 10 to form the cooling zone 132. As shown, the cooling zone 132 can trail behind the elongated radiation zone 120 to propagate an initial crack formed by aspects of the disclosure described more fully below.

The combination of heating and cooling with the optical delivery apparatus 102 and the coolant fluid delivery apparatus 122 can effectively separate the first and second edges 16 and 18 along with the tape 25 applied thereto from the central portion 20 while minimizing or eliminating undesired residual stress, microcracks or other irregularities in the opposed edges 140, 142 of the central portion 20 that may be formed by other separating techniques. Moreover, due to the bent orientation of the bent target segment 54 within the cutting zone 50, the glass ribbon 10 can be properly positioned and stabilized to facilitate precise separating of the first and second edges 16 and 18 during the separating process. Still further, due to the convex surface topography of the upwardly facing convex support surface, the continuous strips of edge trim 150 and 152 can immediately travel away from the central portion 20, thereby reducing the probability that the first and second edges 16 and 18 will subsequently engage (and therefore damage) the first and second broad surfaces 22 and 24 and/or the high quality opposed edges 140, 142 of the central portion 20.

Turning again to FIG. 4, the apparatus 10 may include structures configured to further process the separated first and second edges 16 and 18 and/or the central portion 20 of the glass ribbon 10 downstream from the cutting zone 50. In the illustrated example, a roll assembly 160 is provided for taking up the continuous strips of edge trim 150 and 152 in a continuous fashion while the flexible glass ribbon 10 moves through the apparatus 12.

Referring to FIG. 5, the roll assembly 160 may include a removable winding roll 162 that is rotated using a drive shaft 164. The drive shaft 164 may be connected to a motor 166 for rotating the winding roll 162 at a desired rate (e.g., between about 10 ft/min (0.05 m/s) and 100 ft/min (0.5 m/s), such as about 40 ft/min (0.2 m/s)). In some embodiments, the rate at which the winding roll 162 takes up the continuous strips of edge trim 150 and 152 is about the same rate the flexible glass ribbon 10 moves through the apparatus 12. A controller may be used to control the speed of the various motors. Any feedback mechanisms, such as force sensors may provide torque and/or rotation speed information to the controller for adjusting speed of the motors. The sensors may be used to control winding force realized in the strips of edge trim 150 and 152 to maintain a predetermined winding tension in the roll and/or maintain a specific tension in the strips of edge trim 150 and 152.

The winding roll 162 may be formed of any suitable materials, such as a resin impregnated cardboard, polystyrene or any other disposable materials. The winding roll 16 includes an opening extending therethrough for receiving the drive shaft 164 and may be any suitable outer diameter, such as about six inches or more. The drive shaft 164 may be formed of any suitable material and may be expandable to facilitate assembly and removal of the winding roll 162. Exemplary expandable drive shafts capable of dimensional changes are described in U.S. Pat. No. 7,252,261, assigned to Goldenrod Corporation, Beacon Falls, CT.

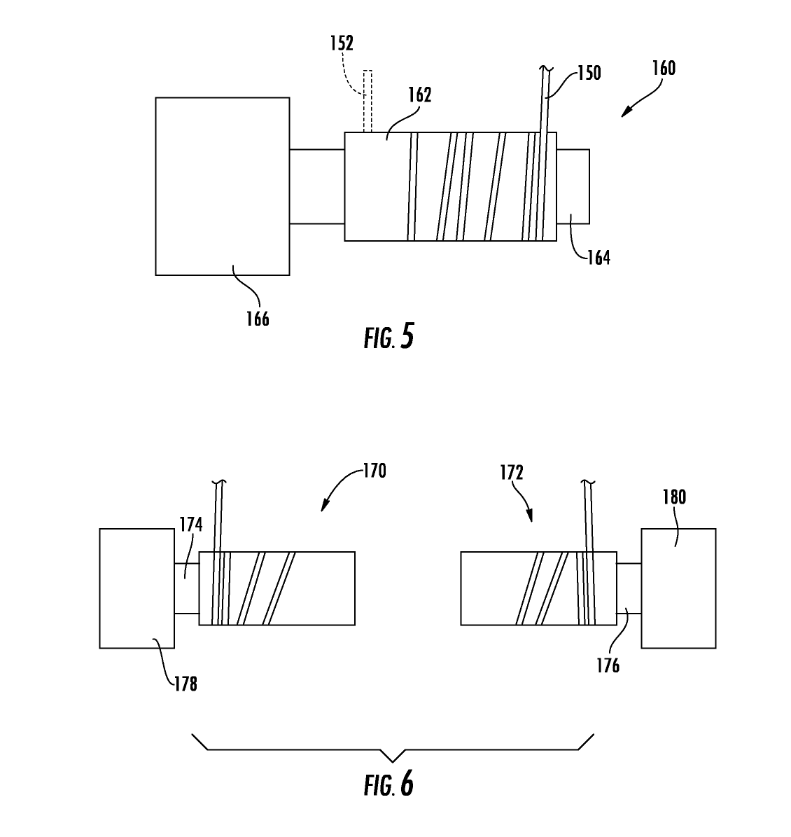

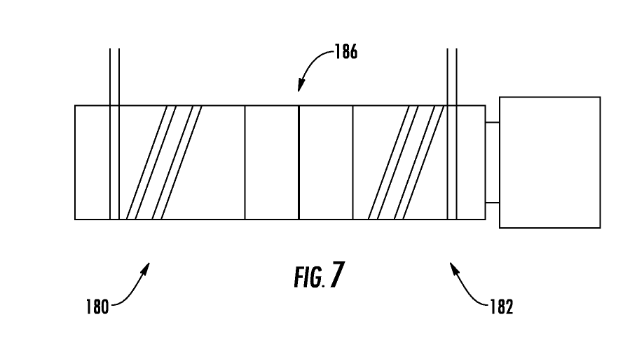

As shown in FIG. 5 a single winding roll 162 may be provided, for example, for winding a single strip of edge trim 150 or 152. In other embodiments, a single winding roll 162 may be used to wind multiple strips of edge trim 150 and 152. Multiple strips of edge trim 150 and 152, however, may introduce a tension differential between the strips of edge trim 150 and 152, for example, due to the fashion in which they are wound about the winding roll 162. In these embodiments, referring to FIG. 6, multiple winding roll portions 170 and 172 may be provided for winding multiple strips of edge trim 150 and 152. The winding roll portions 170 and 172 may be separate, for example, each including its own drive shaft 174 and 176 and motor 178 and 180. In another embodiment, referring to FIG. 7, winding roll portions 182 and 184 may be connected, for example, by a slip clutch assembly or differential winding shaft assembly 186, which can allow movement or rotation of one winding roll portion 182, 184 relative to the other to account for differences in tension between the strips of edge trim 150 and 152.

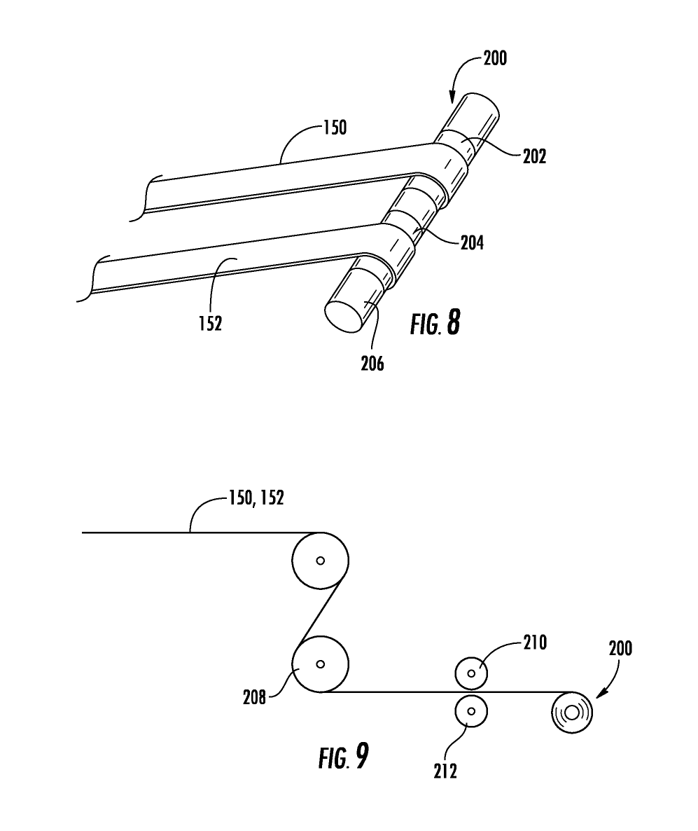

In the above edge winding examples of FIGS. 5-7, a transverse or fishing reel like motion is used in winding the strips of edge trim. Referring to FIG. 8, the strips of edge trim 150 and 152 may be wound within parallel planes on a differential winding shaft assembly 200. The differential winding shaft assembly 200 may rotate at a speed slightly faster than is needed to pull the strips of edge trim 150 and 152 onto winding rolls 202 and 204, but the winding rolls 202 and 204 may be allowed to slip on drive shaft 206 due to a slip clutch arrangement between the drive shaft 206 and winding rolls 202 and 204 (e.g., using an inflatable bladder arrangement) or within the drive shaft 206, itself

Referring to FIG. 9, the strips of edge trim 150 and 152 may be directed through an active tensioning roll 208 to monitor and actively control tension in the strips of edge trim 150 and 152 and then through pinch rolls 210 and 212 that isolate the strips of edge trim 150 and 152 running from the pinch rolls 210 and 212 to the differential winding shaft assembly 200 from the rest of the glass ribbon 10 (FIG. 1). The drive shaft 206 operating at a prescribed torque is isolated from the rest of the glass ribbon 10 upstream of the pinch rolls 210 and 212 such that, for example, no winding vibrations are directed back at the cutting zone 50 (FIG. 1). The trim tension can be controlled to closely match the tension in the rest of the glass ribbon 10 so there are no tension differentials in the cutting zone 50.

The above-described apparatus provides edge trim management for disposal of the continuous strips of edge trim in an efficient and safe manner in a clean room. The apparatus can utilize a roll assembly to roll the continuous strips of edge trim onto a disposable winding roll. The roll assembly can have the ability to simultaneously wind multiple strips of the edge trim after separating the strips of edge trim. Once the winding roll has reached its capacity of edge trim, the edge trim and winding roll can be removed and disposed of

In the previous detailed description, for purposes of explanation and not limitation, example embodiments disclosing specific details are set forth to provide a thorough understanding of various principles of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of various principles of the present invention. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

It should be emphasized that the above-described embodiments of the present invention, particularly any “preferred” embodiments, are merely possible examples of implementations, merely set forth for a clear understanding of various principles of the invention. Many variations and modifications may be made to the above-described embodiments of the invention without departing substantially from the spirit and various principles of the invention. All such modifications and variations are intended to be included herein within the scope of this disclosure and the following claims.

1. A method of managing edge trim of a flexible glass ribbon, the method comprising:
directing the flexible glass ribbon to an edge trimming apparatus including a cutting device, the flexible glass ribbon including a first broad surface and a second broad surface that extend laterally between a first edge and a second edge;
separating the first edge of the flexible glass ribbon as the flexible glass ribbon moves by the cutting device forming a continuous strip of edge trim connected to a central portion of the flexible glass ribbon; and
collecting the continuous strip of edge trim separate from the central portion while the continuous strip of edge trim remains connected to the central portion of the flexible glass ribbon.

2. The method of claim 1, further comprising applying an adhesive tape to the first edge of the flexible glass ribbon prior to removing the first edge of the flexible glass ribbon.

3. The method of claim 2, wherein the continuous strip of edge trim includes the adhesive tape.

4. The method of claim 1, wherein the step of collecting the continuous strip of edge trim includes winding the continuous strip of edge trim on a roll assembly.

5. The method of claim 4, wherein the roll assembly includes a drive shaft and a winding roll disposed about the drive shaft, and the method further comprising winding the continuous strip of edge trim on the winding roll.

6. The method of claim 5 further comprising removing the winding roll from the drive shaft, the continuous strip of edge trim being disposed about the winding roll.

7. An apparatus that manages edge trim of a flexible glass ribbon, the apparatus comprising:
a conveying assembly that directs the flexible glass ribbon in a conveying direction;
an edge trimming apparatus including a cutting device, the cutting device receives the flexible glass ribbon as the flexible glass ribbon moves in the conveying direction and separates a first edge of the flexible glass ribbon as the flexible glass ribbon moves by the cutting device forming a continuous strip of edge trim connected to a central portion of the flexible glass ribbon; and
a roll assembly that collects the continuous strip of edge trim separate from the central portion while the continuous strip of edge trim remains connected to the central portion of the flexible glass ribbon.

8. The apparatus of claim 7, wherein the roll assembly comprises a drive shaft that is driven by a motor and a roll received by the drive shaft, the continuous strip of edge trim winding about the roll.

9. The apparatus of claim 8, wherein the drive shaft is expandable.

10. The apparatus of claim 8, wherein the drive shaft comprises a differential drive shaft assembly.
